(19) United States
(12) Patent Application Publication
(10) Pub. No.: US 2025/0367490 A1
(43) Pub. Date: Dec. 4, 2025

(54) MOISTURE VAPOR PERMEABLE AND WASHABLE MATERIAL FOR CHEMICAL, BIOLOGICAL, RADIATION, AND/OR NUCLEAR PROTECTION

(71) Applicant: NARCOTE CANADA CORPORATION, Granby (CA)

(72) Inventors: Martin FILTEAU, Mont St-Hilaire (CA); François SIMARD, Bromont (CA); Ahmad IBRAHIM, St-Hyacinthe (CA); Joseph Emile LAQUERRE, St-Hyacinthe (CA)

(21) Appl. No.: 18/876,647

(22) PCT Filed: Jun. 23, 2023
(86) PCT No.: PCT/CA2023/050880

§ 371 Date: Dec. 18, 2024

Related U.S. Application Data
(60) Provisional application No. 63/366,877, filed on Jun. 23, 2022.

(51) Int. Cl. A62D 5/00; A41D 31/14; B32B 7/14; B32B 27/12

(52) U.S. Cl. CPC A62D 5/00; A41D 31/14; B32B 7/14; B32B 27/12; B32B 2307/724; B32B 2437/00

(57) ABSTRACT

There is provided a protective fabric including a textile substrate: a monolithic moisture vapor permeable polymer membrane extending over at least a portion of the textile substrate, the monolithic moisture vapor permeable polymer membrane being joined to the textile substrate with a discontinuous adhesive film; and a catalytic layer and a catalytic neutralization layer extending over the monolithic moisture vapor permeable polymer membrane, the catalytic layer and the catalytic neutralization layer being collectively configured to degrade potentially hazardous compounds into non-lethal products and dissipate the same into surrounding environment, The protective fabric may be included in a protective garment. Manufacturing methods are also provided.

### TECHNICAL FIELD

The technical field generally relates to a formulation and application method on a textile substrate to produce a waterproof and moisture vapour permeable barrier fabric for protective garments. More specifically, the present disclosure relates to material for protective garments used where risks of exposure to chemical, biological, radiological and/or nuclear particles may be present.

### BACKGROUND

Protection of people against chemical and biological, or otherwise potentially hazardous agents, may be useful in some context. For example, functional protective garments or equipment may be needed for workers of some industries, such as, for example firefighters, police officers, medical workers, chemical and biological researchers, environmental health workers, pesticide handlers, soldiers and many others. One of the objectives of functional protective garments or equipment may be contributing to the improvement and maintenance of the health and well-being of users or workers exposed to potentially hazardous agents.

Existing protective garments and equipment should be decontaminated after exposure to a potentially hazardous agent. The decontamination process reduces or at least mitigate the risks of the user being more directly exposed to the potentially hazardous agents once worn again by the user.

Known from the applicant are U.S. Pat. Nos. 4,943,475; 5,391,426; and 6,395,383. Known from the applicant are also European Patent Applications Nos. 1700620A2; and 06300223.2. Known from the applicant is also Canadian Patent No. 2,501,146. Generally, these techniques rely on selectively permeable materials that possess high water vapor transmission properties. Nonlimitative examples of such materials are hydrophilic polymers, like polyethylenimine (PEI) or amine polymers combined with other polymer such as polyvinyl alcohol (PVOH), and polyvinyl alcohol co-ethylene. However, these hydrophilic polymers show do not exhibit or produce a noticeable catalytic effect, meaning that these materials cannot neutralize chemical, biological, noxious or other harmful agents. Another drawback associated with such materials is that they do not provide sufficient resistant to launderings, which limit their use over time.

There remains a need in the art for protective textiles and fabrics used in some of the applications listed above, that would allow improving the comfort of the user, while maintaining the same security level for the wearer.

### SUMMARY

In accordance with one aspect, there is provided a protective fabric. The protective fabric includes:
a textile substrate;
a monolithic moisture vapor permeable polymer membrane extending over at least a portion of the textile substrate, the monolithic moisture vapor permeable polymer membrane being joined to the textile substrate with a discontinuous adhesive layer; and
a catalytic layer and a catalytic neutralization layer extending over the monolithic moisture vapor permeable polymer membrane, the catalytic layer and the catalytic neutralization layer being collectively configured to degrade potentially hazardous compounds into non-lethal products and dissipate the same into surrounding environment.

In some embodiments, the protective fabric further includes a cover layer disposed over the catalytic layer and the catalytic neutralization layer, wherein the cover layer is configured to block chemical, biological, radiation and/or nuclear toxic particles.

In some embodiments, one of the catalytic layer and the catalytic neutralization layer is joined to the cover with a second discontinuous adhesive film.

In some embodiments, the catalytic layer is sandwiched between the monolithic moisture vapor permeable polymer membrane and the catalytic neutralization layer.

In some embodiments, the textile substrate, the monolithic moisture vapor permeable polymer membrane, the catalytic layer and the catalytic neutralization layer are water-vapor permeable. In some embodiments, the total heat loss (THL) is about 500 W/m².

In some embodiments, the catalytic layer and the catalytic neutralization layer are particulate impermeable.

In accordance with one aspect, there is provided a protective garment. The protective garment includes:
a protective fabric, the protective fabric including:
   a textile substrate;
   a monolithic moisture vapor permeable polymer membrane extending over at least a portion of the textile substrate, the monolithic moisture vapor permeable polymer membrane being joined to the textile substrate with a first discontinuous adhesive film; and
   a catalytic layer and a catalytic neutralization layer extending over the monolithic moisture vapor permeable polymer membrane, the catalytic layer and the catalytic neutralization layer being collectively configured to degrade potentially hazardous compounds into non-lethal products and dissipate the same into surrounding environment.

In some embodiments, the protective garment further includes a cover layer disposed over the catalytic layer and the catalytic neutralization layer, wherein the cover layer is configured to block chemical, biological, radiation and/or nuclear toxic particles.

In some embodiments, one of the catalytic layer and the catalytic neutralization layer is joined to the cover with a second discontinuous adhesive film.

In some embodiments, the catalytic layer is sandwiched between the monolithic moisture vapor permeable polymer membrane and the catalytic neutralization layer.

In some embodiments, the textile substrate, the monolithic moisture vapor permeable polymer membrane, the catalytic layer and the catalytic neutralization layer are water-vapor permeable.

In accordance with one aspect, there is provided a process for manufacturing a protective fabric. The process includes:
preparing first composition components;
dispensing the first composition components on a monolithic moisture vapor permeable polymer membrane extending over at least a portion of the textile substrate and curing the same at a temperature ranging between about 100° C. to about 180° C. to obtain a catalytic layer;
preparing second composition components; and
dispensing the second composition components on the catalytic layer and curing the same at a temperature between about of 100° C. to about 220° C. to obtain a catalytic neutralization layer.

In some embodiments, the process further includes providing a cover layer disposed over the catalytic layer and the catalytic neutralization layer, wherein the cover layer is configured to block chemical, biological, radiation and/or nuclear toxic particles.

In some embodiments, the process further includes joining the monolithic moisture vapor permeable polymer membrane and the textile substrate with a discontinuous adhesive film.

In some embodiments, the process further includes joining one of the catalytic layer and the catalytic neutralization layer to the cover layer with a second discontinuous adhesive film.

In some embodiments, the textile substrate, the monolithic moisture vapor permeable polymer membrane, the catalytic layer and the catalytic neutralization layer are water-vapor permeable.

In some embodiments, the catalytic layer and the catalytic neutralization layer are particulate impermeable.

In accordance with one aspect, there is provided a composition which, when applied to a fabric, exhibits an enhanced protection against noxious warfare agents. The composition is associated with a self-detoxifying catalytic effect neutralizing chemical and/or biological warfare agents present in the environment.

In some embodiments, the fabric including such a composition may be implemented in protective clothing and equipment. The fabric provides protection for the users against a variety of noxious agents without having a negative impact on the performance of the users. More particularly, the clothing and equipment maintain personal comfort, notably in terms of breathability and ensure safety. Of note, the expression “breathability” refers to a property of materials being water impermeable while having moisture vapor permeability capabilities. Breathability is sometimes understood as the ability of a fabric or a material to allow perspiration and to diffuse heat the outside of a body (“moisture vapour transmission”), which can be associated with improved comfort. In the field of chemical protection against chemical and/or biological warfare agents, protective fabric, membrane, clothing, or equipment should meet certain requirements, and should be lightweight, moisture vapor permeable and should selectively block toxic agents. This approach relies, amongst other things, on the use of selectively permeable materials. The selective permeable membranes or semi-selective permeable materials present different advantages, in comparison with non-breathable products or relatively low-breathable products, especially regarding comfort.

Selective permeable materials are flexible, they possess characteristics that facilitate the transport of water vapor, thus allowing sweat to penetrate the materials to provide, for example, comfort to the wearer, while blocking entry of chemical, biological noxious or harmful agents.

In some embodiments, the fabric including the composition described herein provides sufficient resistant to launderings.

In accordance with one aspect, there is provided fabrics materials offering an enhanced protection against noxious warfare agents while enabling the user to launder the garment several times to avoid having to dispose of it after being exposed to noxious chemicals. Other properties may include enhanced water vapor permeability, a catalytic effect in neutralizing the harmful and noxious agents at different relative humidity levels, and adequate laundering resistance.

In some embodiments, the composition includes from about 10% to about 75% by weight of a MVP substrate media, from about 10% to about 60% by weight of an aliphatic amine or any hydrophilic amine polymer or monomer, from about 0% to about 5% by weight of graphene, and from about 10% to about 70% by weight of water. In some embodiments, the composition may comprise from about 0% to about 10% by weight of a surfactant agent, from about 0% to about 10% by weight of an epoxy resin or of a crosslinking agent, from about 0% to about 80% by weight of a polyvinyl acetate polymer or copolymer, from about 0% to about 20% by weight of a polyvinyl alcohol polymer or copolymer, from about 0% to about 70% by weight of a polyurethane polymer, from about 0% to about 60% by weight of an acrylic polymer, from about 0% to about 5% by weight of one or more metal salts or metal oxides, from about 0% to about 10% by weight of defoamer agent. In another embodiment, the aliphatic amine or hydrophilic amine polymer or monomer may be replaced by a vinyl amine and polyvinyl alcohol copolymer. In some embodiments, the protective fabric does not include polyvinyl alcohol. In some embodiments, the composition may include sodium sulfate, for example between 2% to 5% by weight.

In accordance with one aspect, there is provided a process for the preparation of a laminated support comprising graphene. The process includes the following steps: a) mixing the components for each of the two compositions; b) applying the first composition to a selected support made of a textile substrate and a membrane; c) curing the resulting laminated support at a temperature at a range of about 100° C. to about 180° C.; d) applying the second composition over the first one; e) curing the resulting laminated support at a temperature at a range of about 100° C. to about 220° C. In some embodiments, the resulting assembly may be secured to a further layer by combining the resulting assembly to a second textile substrate by means of discontinuous adhesive deposition. In some embodiments, the process includes a two-step application method, wherein a second application step includes applying the second composition on a transfer paper, curing the same, applying the first composition (base coat), and then curing the same. In some embodiments, applying the first and/or second composition(s) may include directly applying the same.

Other features and advantages of the present invention will be better understood upon a reading of embodiments thereof with reference to the appended drawings.

### BRIEF DESCRIPTION OF THE DRAWINGS

FIG. 1 is a schematic representation of a protective fabric, in accordance with one embodiment.

FIG. 2 is a schematic representation of a protective fabric, in accordance with one embodiment.

FIG. 3 shows a protective fabric, in accordance with one embodiment.

### DETAILED DESCRIPTION

In the following description, similar features in the drawings have been given similar reference numerals, and, to not unduly encumber the figures, some elements may not be indicated on some figures if they were already identified in one or more preceding figures. It should also be understood herein that the elements of the drawings are not necessarily depicted to scale, since emphasis is placed upon clearly illustrating the elements and structures of the present embodiments.

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

It will be appreciated that positional descriptors indicating the position or orientation of one element with respect to another element are used herein for ease and clarity of description and should, unless otherwise indicated, be taken in the context of the figures and should not be considered limiting. It will be understood that spatially relative terms (e.g., “outward” and “inward”, “frontward” and “rearward”, “front” and “rear”, “left” and “right”, “top” and “bottom” and “outer” and “inner”) are intended to encompass different positions and orientations in use or operation of the present embodiments, in addition to the positions and orientations exemplified in the figures.

The present description generally refers to textile or fabric technology, and more particularly to a protective fabric for use in protective garments. The protective fabric may have particulate-impermeable properties (sometimes referred to as “particulate barrier” or “particulate-barrier properties”), air-permeable properties, liquid-permeable properties and/or antimicrobial properties. For example, the microporous reinforcement fabric may be used in firefighter garments or protective garments worn by other first responders, or any activities that would require or at least benefit from a protection from potentially hazardous agents.

The term “fabric” refers specifically to a woven, non-woven or knitted material, and more generally to flexible materials comprising a network of natural fibers, artificial fibers or combination thereof. Unless otherwise specified, the description of the fabric is applicable to woven, non-woven and knitted materials, as well as to other materials that will be later introduced and described.

The term “textile” as used herein is meant to generally refer to an element manufactured from natural or synthetic (i.e., man-made) fibers or filaments or monofilaments. Non-limiting examples of synthetic fibers or filaments include polyester, polyamide (e.g., Nylon) aramid or meta-aramid (e.g., Kevlar™, Technora™, Twaron™, Nomex™, Teijinvonex™, Kermel™ and Hecracron™), Zylon™, polyethylene (PE), polytetrafluoroethylene (ePTFE), polyphenylene sulfide (PPS), polyetheretherketone (PEEK), acrylic, modacrylic, polyurethane (e.g., spandex or Lycra™), oleofin fibers, polylactide fibers (ingeo), metallic fibers (e.g., lurex) and milk or casein protein fibers. Non-limiting examples of natural fibers or filaments include wool, silk, cashmere, hemp, flax (linen), cotton and bamboo fibers. Non-limiting examples of such elements include yarns, threads and fabrics.

In the current disclosure, the expression “mechanical properties” or the like may include, but are not limited, to fiber strength, elongation, elasticity, abrasion resistance and modulus of elasticity. Measurements of such mechanical properties may be achieved using techniques known in the art.

Broadly described, the technology concerns materials, compositions and fabrics for chemical, biological, radiation and nuclear (CBRN) protection. CBRN textile fabrics have protection, chemical adsorption. decontamination capabilities or properties.

Recent approaches relate to chemical decontamination, neutralization, decomposition and/or self-detoxifying rather than chemical adsorption capabilities. Existing techniques encompass decontaminating and reactive fabrics and membranes, such as polymer composition and method for removing contaminates from a substrate (see U.S. Pat. No. 9,458,419); textile fibers having photocatalytic properties for degrading chemical or biological agents and use thereof (see U.S. Pat. No. 9,441,324); breathable chemical, biological, radiation, and/or nuclear protection fabric or material (see U.S. Pat. No. 9,475,263); and polymeric composition for the neutralization of noxious agents (see U.S. Pat. No. 8,920,825). Examples of existing technologies for chemical decontamination, neutralization, decomposition and/or self-detoxifying are nanoparticle enhanced activated carbon fabrics (see US20150352392); functional protective material with a reactively finished membrane and protective clothing (see US20110113538); fibers for decontamination of chemical and biological agents (see US20100113857); and functionalization of polymers with reactive species having bond-stabilized decontamination activity (see US20090012204).

There is a need to develop a composition which, when applied to a fabric, will show an enhanced protection against noxious warfare agents by adding a self-detoxifying catalytic effect in neutralizing the chemical and/or biological warfare agents present in the environment.

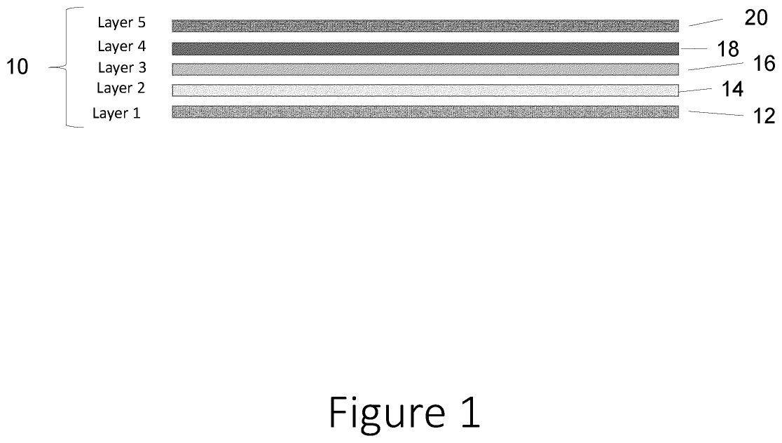

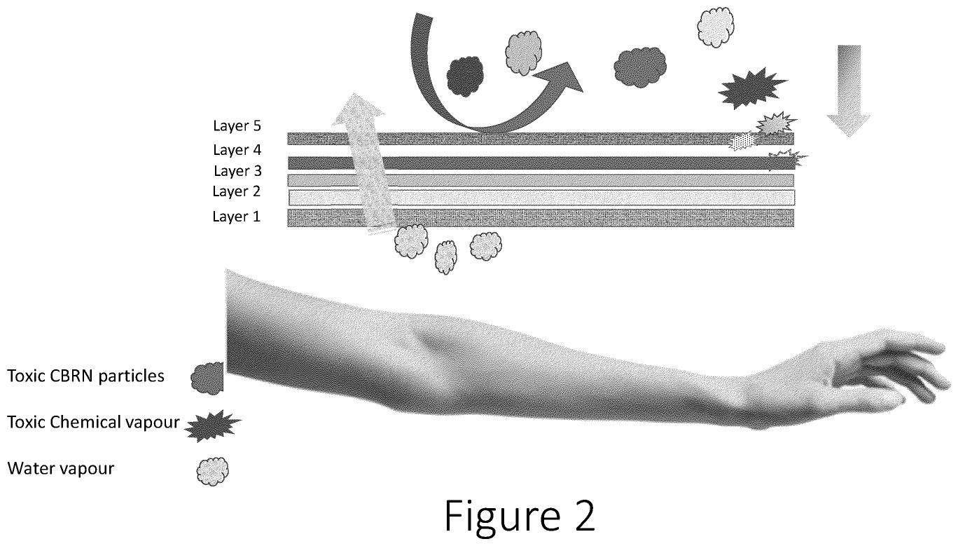

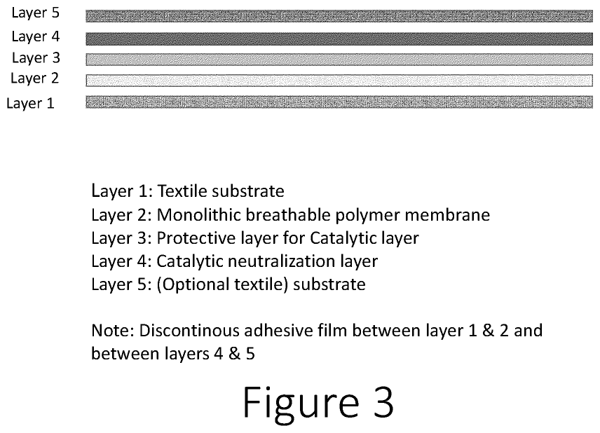

In accordance with one aspect, and with reference to FIGS. 1 to 3, there is provided a protective fabric 10. The protective fabric 10 includes a textile substrate 12, a monolithic moisture vapor permeable polymer membrane 14, a catalytic layer 16 and a catalytic neutralization layer 18.

The monolithic moisture vapor permeable polymer membrane extends over at least a portion of the textile substrate. The monolithic moisture vapor permeable polymer membrane is mechanically joined to the textile substrate with a discontinuous adhesive film.

The catalytic layer and the catalytic neutralization layer extend over the monolithic moisture vapor permeable polymer membrane. The catalytic layer and the catalytic neutralization layer are collectively configured to degrade potentially hazardous compounds into non-lethal products and dissipate the same into surrounding environment, in a way that is not dangerous to the user.

In some embodiments, the protective fabric may include a cover layer 20 disposed over the catalytic layer and the catalytic neutralization layer. The cover layer is adapted or configured to block chemical, biological, radiation and/or nuclear toxic particles.

In some embodiments, one of the catalytic layer and the catalytic neutralization layer is joined to the cover with a second discontinuous adhesive layer. In some embodiments, the catalytic layer is sandwiched between the monolithic moisture vapor permeable polymer membrane and the catalytic neutralization layer, meaning that the catalytic neutralization layer extends over the catalytic layer. In other embodiments, the configuration may be inverted, meaning that the catalytic may extend over the catalytic neutralization layer.

In some embodiments, the textile substrate, the monolithic moisture vapor permeable polymer membrane, the catalytic layer and the catalytic neutralization layer are water-vapor permeable, meaning that the provide the protective fabric with water-vapor permeability properties. In some embodiments, the total heat loss (THL) is about 500 W/m².

In some embodiments, the catalytic layer and the catalytic neutralization layer may be particulate impermeable, and so may provided the protective fabric with particulate impermeability properties.

The protective fabric may be implemented into a protective garment. In these embodiments, the protective garment includes a protective fabric, which may be embodied by one of the embodiments of the protective fabric being herein described. In some embodiments, the protective fabric includes a textile substrate, a monolithic moisture vapor permeable polymer membrane, a catalytic layer and a catalytic neutralization layer. The monolithic moisture vapor permeable polymer membrane extends over at least a portion of the textile substrate. The monolithic moisture vapor permeable polymer membrane is joined to the textile substrate with a first discontinuous adhesive film. The catalytic layer and the catalytic neutralization layer extend over the monolithic moisture vapor permeable polymer membrane and are collectively adapted or configured to degrade potentially hazardous compounds into non-lethal products and dissipate the same into surrounding environment.

In some embodiments, the protective garment may further include a cover layer disposed over the catalytic layer and the catalytic neutralization layer, wherein the cover layer is configured to block chemical, biological, radiation and/or nuclear toxic particles.

In some embodiments, one of the catalytic layer and the catalytic neutralization layer is joined to the cover with a second discontinuous adhesive film. In some embodiments, the catalytic layer is sandwiched between the monolithic moisture vapor permeable polymer membrane and the catalytic neutralization layer, meaning that the catalytic neutralization layer extends over the catalytic layer. In other embodiments, the configuration may be inverted, meaning that the catalytic may extend over the catalytic neutralization layer.

In some embodiments, the textile substrate, the monolithic moisture vapor permeable polymer membrane, the catalytic layer and the catalytic neutralization layer are water-vapor permeable.

In accordance with another aspect, there is provided a process for manufacturing a protective fabric. The process includes preparing first composition components; dispensing the first composition components on a monolithic moisture vapor permeable polymer membrane extending over at least a portion of the textile substrate and curing the same at a temperature ranging between about 100° C. to about 180° C. to obtain a catalytic layer; preparing second composition components; and dispensing the second composition components on the catalytic layer and curing the same at a temperature between about of 100° C. to about 220° C. to obtain a catalytic neutralization layer.

In some embodiments, the process may further include providing a cover layer disposed over the catalytic layer and the catalytic neutralization layer, wherein the cover layer is configured to block chemical, biological, radiation and/or nuclear toxic particles.

In some embodiments, the process may further include joining the monolithic moisture vapor permeable polymer membrane and the textile substrate with a discontinuous adhesive film.

In some embodiments, the process may further include joining one of the catalytic layer and the catalytic neutralization layer to the cover layer with a second discontinuous adhesive film.

In some embodiments, the textile substrate, the monolithic moisture vapor permeable polymer membrane, the catalytic layer and the catalytic neutralization layer are water-vapor permeable.

In some embodiments, the catalytic layer and the catalytic neutralization layer are particulate impermeable.

The protective clothing and equipment are expected to provide protection for the users against a variety of noxious agents without having a negative impact on the performance of the users. More particularly, the clothing and equipment have to maintain personal comfort and ensure safety, notably in terms of breathability and/or ease of movement.

In the field of chemical protection against chemical and/or biological warfare agents, the protective fabric, membrane, clothing, or equipment should be lightweight, moisture vapor permeable and should selectively block toxic agents, which may be achieve by the combination of the layers and membranes being herein described. The selective permeable membranes or semi-selective permeable materials according to the present technology may present different advantages in comparison with non-breathable products or relatively low-breathable products, especially regarding comfort. Selective permeable materials are flexible and possess properties or characteristics that facilitate the transport of water vapor, thus allowing sweat to penetrate the materials to provide, for example, comfort to the wearer, while blocking entry of chemical, biological noxious or harmful agents, which may be damageable to their health.

It is generally a challenge to clean CBRN protective fabric, as their catalytic neutralization effect and blocking efficiency to harmful or noxious agents tend to be affected by the cleaning or decontaminating process. The present technology allows the user to clean, launder or decontaminate the fabric, or the garment including such a fabric several times without substantially affecting the properties thereof. As such, the fabrics and garments described herein do not require to the disposal of the materials after being exposed to noxious chemicals, i.e., the protective fabrics and the protective garment are reusable.

The technology described herein has several advantages over existing techniques, notably in terms of enhanced water vapor permeability, a catalytic effect in neutralizing the harmful and noxious agents at different relative humidity levels, and adequate laundering resistance.

In some embodiments, the composition includes from about 10% to about 75% by weight of a MVP substrate media, from about 10% to about 60% by weight of an aliphatic amine or any hydrophilic amine polymer or monomer, from about 0% to about 5% by weight of graphene, and from about 10% to about 70% by weight of water. In some embodiments, the composition may comprise from about 0% to about 10% by weight of a surfactant agent, from about 0% to about 10% by weight of an epoxy resin or of a crosslinking agent, from about 0% to about 80% by weight of a polyvinyl acetate polymer or copolymer, from about 0% to about 20% by weight of a polyvinyl alcohol polymer or copolymer, from about 0% to about 70% by weight of a polyurethane polymer, from about 0% to about 60% by weight of an acrylic polymer, from about 0% to about 5% by weight of one or more metal salts or metal oxides, from about 0% to about 10% by weight of defoamer agent. In another embodiment, the aliphatic amine or hydrophilic amine polymer or monomer may be replaced by a vinyl amine and polyvinyl alcohol copolymer. In some embodiments, the protective fabric does not include polyvinyl alcohol.

In accordance with one aspect, there is provided a process for the preparation of a laminated support comprising graphene. The process includes the following steps: a) mixing the components for each of the two compositions; b) applying the first composition to a selected support made of a textile substrate and a membrane; c) curing the resulting laminated support at a temperature at a range of about 100° C. to about 180° C.; d) applying the second composition over the first one; e) curing the resulting laminated support at a temperature at a range of about 100° C. to about 220° C. In some embodiments, the resulting assembly may be secured to a further layer by combining the resulting assembly to a second textile substrate by means of discontinuous adhesive deposition.

In accordance with one aspect, there is provided a protective fabric including a graphene-free top coat (sometimes referred to as a “top layer”). In some embodiments, the top coat includes more than 90% of polyurethane. Of note, a catalyst and a crosslinker may be added to the polyurethane. In some embodiments, the polyurethane is a water-based polyurethane. In some embodiments, the polyurethane is an organic solvent-based polyurethane. In some embodiments, other liquid-based polyurethane derivatives can be used. In some embodiments, the liquid-based polyurethane can be applied by coating.

### Examples of Results

The section below provides examples of embodiments and/or results related to the technology having been insofar described. The following section should not be interpreted as being limitative and serves an illustrative purpose only.

In some embodiments, the protective fabric includes a flexible material supported by one or two textile substrate which act as a barrier to noxious chemical in solid, liquid or vapo form. The flexible material may be composed of several polymeric layers which provide a RET of at least 30≤30 m². Pa/W, according to the NFPA 1994-2018, Sec 8.19, par 7.4.2.7 method. The catalytic neutralization barrier layer may be covered by a second composition layer to protect it from launderings. The chemical barrier layer may comprise graphene to enhance process stability, improve the process conditions, add additional properties and increase the rheological stability of the formulation. The protective fabric may be free of PFAS (PerFluoroAlkylated substances). The protective fabric may provide better flexibility over existing product that reduces fatigue for the wearer. The overall thickness of the protective fabric (without fabrics layers and with polymeric membrane) may vary from about 50 microns to about 150 microns.

In some embodiments, the protective fabric includes a textile substrate (knitted, woven or non-woven), a monolithic moisture vapor permeable membrane, a composition layer for the catalytic neutralization of chemicals, a protective layer for the second layer, other optional textile substrate (knitted, woven or non-woven). Advantageously, the protective fabric according to these embodiments does not include activated carbon, thereby preventing the retention of potentially harmful products. The catalytic protection is done on two layers, rather than only one layer, which allows a better resistance to washing. The product can be made without using Teflon. Teflon, from the PFAS family, represents an irritant for the environment because of its persistence in nature. The top layer may be selected or changed according to the needs of the wearer.

The technology herein described allows for protection against common industrial chemical penetration, viral and blood born pathogen penetration as well as basic radioactive dust particles using a novel barrier technology for manufacturing barrier membranes used in the manufacturing of Class 3 and Class 4 NFPA 1994 (National Fire Protection Agency) Ensembles and clothing for CBRN (Chemical Biological Radiological Nuclear) protection.

Related to this type of protective clothing, inward leakage, liquid penetration and chemical permeation properties are listed as requirements in NFPA 1994:2013 and also in the proposed NFPA 1994:2018 edition. In Europe, standards EN 1073-2, EN 14126, EN 14605 type 4, EN ISO 13982-1 type 5, EN 13034 type 6 and used to define nuclear, biological and chemical requirements.

The key standards and test methods related to Class 3 NFPA Ensembles are listed in the Table below. The table below presents the Specific details regarding Class 3 requirements of PROPOSED NFPA 1994:2018 edition and the results obtained for the commercial Class 3 NFPA Lion ERS.

| | | Test | | | | |
|---|---|---|---|---|---|---|
| | | Requirement | | | | |
| | Test Name | Paragraph | Test Method | Specification | Unit | Prior Art |
| | Sample | NA | NA | NA | g/m² | — |
| | Surface | | | | | |
| | mass (gsm) | | | | | |
| Challenge | Simulation | NA | GCTTG 153- | NA | min | 17 |
| | of gas | | 18 | | | |
| | penetration | | | | | |
| | test with | | | | | |
| | liquid | | | | | |
| | simulant | | | | | |
| Challenge | Simulation | After washing, | GCTTG 153- | NA | min | 16 |
| | of gas | domestic, | 18 | | | |
| | penetration | AATCC 135- | | | | |
| | test with | 19, 1 Wash (2, | | | | |
| | liquid | III); double | | | | |
| | simulant | rinse; Dry (B) | | | | |
| Comfort | Total Heat | NFPA 1990- | ASTM F 1868 | ≥200 | W/m² | 468 |
| | Loss, THL | 2018, Sec 8.8, | Part C | W/m² | | |
| | | par 7.4.2.6 | | | | |
| | Evaporative | NFPA 1990- | ISO 11092 | ≤30 | m² · Pa/W | 17.9 |
| | Resistance, | 2018, Sec | | m² · Pa/W | | |
| | Ret | 8.19, par | | | | |
| | | 7.4.2.7 | | | | |
| | Thermal | not required | ISO 11092 | NA | clo | 0.10 |
| | Resistance, | | | | | |
| | Rct (clo) | | | | | |
| | Water | not required | ASTM E96, | NA | g/m² · h | 28.0 |
| | Vapor | | Proc B | | | |
| | Permeability | | | | | |
| Others | Burst | NFPA 1990- | ASTM D751, | ≥135N | N | 791 |
| | Strength | 2018, Sec 8.9, | p18.3 | | | |
| | | par 7.4.2.3 | | | | |

The material shall provide protection against toxic industrial chemical and chemical warfare agent in both liquid and vapour form. In addition, this protective clothing must be resistant to virus penetration and laundering resistant (at least 5 launderings). This represents a significant advantage over existing activated carbon based material which act as a filter thus adsorb noxious chemicals by trapping it in the carbon micropores. This makes the garment unusable after exposure. Moreover, contamination of the carbon can also be caused by other less toxic vapours such as exhaust from vehicles or even human sweat (from the inside). The activated carbon technology also needs to be thicker thus heavier to act as an efficient barrier causing an undesirable thermal load on the wearer.

The technology brings the added advantage over available products to be more supple (20 to 50% more (depending on the fabric support used) according to test FTMS 191A Method 5206) and can be made without using any PerFluoroAlkylated Substances which their usage for garments is being more and more restricted for environmental and health concerns.

One of the objectives is to develop barrier membranes used in the manufacturing of Class 3 and Class 4 NFPA (National Fire Protection Agency) Ensembles and clothing for CBRN (Chemical Biological Radiological Nuclear) protection.

Specific objectives are to meet requirements as listed in NFPA 1994:2013 and 2018 editions: inward leakage protection and pass the shower test (seams included); liquid penetration protection; and chemical permeation protection

In addition, the protective clothing shall meet these other requirements: virus resistance, blood-born pathogens; and wash resistance (5).

### Mechanism

The technology is not only a barrier, but also incorporates a neutralizing technology to protect against lethal chemical penetration. The de-halogenation occurs at the surface of the membrane and dissociates chemical warfare agents into non-lethal chemicals. These bi-products rendered inoffensive quickly dissipated without causing any concern to the environment.

Results from various tests will now be presented.

| | | | CLASS |
|---|---|---|---|
| TEST | REQUIREMENT | | 3 |
| Chemical LIQUID permeation | HD (sulfur mustard) | | 10 g |
| resistance | GD (Soman) | | 10 g |
| | DMS (Dimethyle sulfate) | | 10 g |
| | Sulfuric acid 93.1% | | 10 g |
| | Tetrachloroethylene | | 10 g |
| | Toluene | | 10 g |
| Chemical VAPOUR permeation | Acrolien | | ✓ |
| resistance | Acrylonitrile | | ✓ |
| | Amonia | | ✓ |
| | Chlorine | | ✓ |
| | Diethylamine | | |
| | Ethyl Acetate | | |
| Burst strength [symbol] | ≥200N | | |
| | ≥156N | | |
| | ≥135N | | ✓ |
| [symbol] Puncture propagation tear | ≥49N | | |
| resistance | ≥31N | | |
| | ≥25N | | ✓ |
| Resistance [symbol] Cold temperature | Bending moment | | ✓ |
| | of ≤0.057N · angular | | |
| | deflection of | | |
| | 60°at −25° C. | | |
| Viral Penetration resistance | No penetration for 1 hr | | ✓ |
| Flammability resistance | After flame ≤2.0 | | |
| | does not melt and drip | | |
| Total Heat Loss | ≥200 | W/m2 | ✓ |
| | ≥450 | W/m2 | |
| Evaporative Resistance | ≤30 | Pa m2/W | ✓ |
| Seam/closure breaking strength | ≥67N/25 | mm | |
| | ≥34N/25 | mm | ✓ |

Examples of results obtained during tests on four samples are presented in the table below:

| | Sample | THL (W/m²) | Rₑₜ (m² · Pa/W) |
|---|---|---|---|
| 1 | XP 000323 | 840 ± 60.85 | 4.3 ± 0.97 |
| 2 | XP 000324 | 770.50 ± 73.41 | 8.36 ± 0.60 |
| 3 | XP 000325 | 735.29 ± 15.99 | 5.92 ± 0.25 |
| 4 | XP 000326 | 595.82 ± 67.83 | 14.32 ± 0.0.79 |
| | Existing technology | 468 | 17.9 |
| | Requirement | >200 W/m² | ≤30 m² · Pa/W |

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope defined in the current description and in the claims.

1. A protective fabric, the protective fabric comprising:
a textile substrate;
a monolithic moisture vapor permeable polymer membrane extending over at least a portion of the textile substrate, the monolithic moisture vapor permeable polymer membrane being joined to the textile substrate with a discontinuous adhesive film; and
a catalytic layer and a catalytic neutralization layer extending over the monolithic moisture vapor permeable polymer membrane, the catalytic layer and the catalytic neutralization layer being collectively configured to degrade potentially hazardous compounds into non-lethal products and dissipate the same into surrounding environment.

2. The protective fabric of claim 1, further comprising a cover layer disposed over the catalytic layer and the catalytic neutralization layer, wherein the cover layer is configured to block chemical, biological, radiation and/or nuclear toxic particles.

3. The protective fabric of claim 2, wherein one of the catalytic layer and the catalytic neutralization layer is joined to the cover with a second discontinuous adhesive film.

4. The protective fabric of claim 1, wherein the catalytic layer is sandwiched between the monolithic moisture vapor permeable polymer membrane and the catalytic neutralization layer.

5. The protective fabric of claim 1, wherein the textile substrate, the monolithic moisture vapor permeable polymer membrane, the catalytic layer and the catalytic neutralization layer are each water-vapor permeable.

6. The protective fabric of claim 1, wherein the catalytic layer and the catalytic neutralization layer are each particulate impermeable.

7. A protective garment, the protective garment comprising:
a protective fabric, the protective fabric comprising:
a textile substrate;
a monolithic moisture vapor permeable polymer membrane extending over at least a portion of the textile substrate, the monolithic moisture vapor permeable polymer membrane being joined to the textile substrate with a first discontinuous adhesive film; and
a catalytic layer and a catalytic neutralization layer extending over the monolithic moisture vapor permeable polymer membrane, the catalytic layer and the catalytic neutralization layer being collectively configured to degrade potentially hazardous compounds into non-lethal products and dissipate the same into surrounding environment.

8. The protective garment of claim 7, further comprising a cover layer disposed over the catalytic layer and the catalytic neutralization layer, wherein the cover layer is configured to block chemical, biological, radiation and/or nuclear toxic particles.

9. The protective garment of claim 8, wherein one of the catalytic layer and the catalytic neutralization layer is joined to the cover with a second discontinuous adhesive film.

10. The protective garment of claim 7, wherein the catalytic layer is sandwiched between the monolithic moisture vapor permeable polymer membrane and the catalytic neutralization layer.

11. The protective garment of claim 7, wherein the textile substrate, the monolithic moisture vapor permeable polymer membrane, the catalytic layer and the catalytic neutralization layer are water-vapor permeable.

12. A process for manufacturing a protective fabric, the process comprising:
preparing first composition components;
dispensing the first composition components on a monolithic moisture vapor permeable polymer membrane extending over at least a portion of the textile substrate and curing the same at a temperature ranging between about 100° C. to about 180° C. to obtain a catalytic layer;
preparing second composition components; and
dispensing the second composition components on the catalytic layer and curing the same at a temperature between about of 100° C. to about 220° C. to obtain a catalytic neutralization layer.

13. The process of claim 12, further comprising providing a cover layer disposed over the catalytic layer and the catalytic neutralization layer, wherein the cover layer is configured to block chemical, biological, radiation and/or nuclear toxic particles.

14. The process of claim 13, further comprising joining the monolithic moisture vapor permeable polymer membrane and the textile substrate with a discontinuous adhesive film.

15. The process of claim 14, further comprising joining one of the catalytic layer and the catalytic neutralization layer to the cover layer with a second discontinuous adhesive film.

16. The process of claim 12, wherein the textile substrate, the monolithic moisture vapor permeable polymer membrane, the catalytic layer and the catalytic neutralization layer are water-vapor permeable.

17. The process claim 12, wherein the catalytic layer and the catalytic neutralization layer are particulate impermeable.
